(19) United States
(12) Patent Application Publication
(10) Pub. No.: US 2008/0019391 A1
(43) Pub. Date: Jan. 24, 2008

(54) Uniform message header framework across protocol layers

(75) Inventor: Travis O. Breitkreutz, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/489,461

(22) Filed: Jul. 20, 2006

(51) Int. Cl. H04J 3/16

(52) U.S. Cl. 370/466

(57) ABSTRACT

A method of communicating messages includes sending a message. The message has a first protocol data unit (PDU) having a first data portion and a first header portion. The first header portion has a first set of fields containing first data and arranged according to a first structure. The first data portion has a first service data unit (SDU) having a second data portion and a second header portion. The second header portion has the first set of fields containing second data and arranged according to the first structure. The message is received and the first data and the second data for each of the first and second header portions are processed using the same header processing protocol. The first data portion is processed according to a first protocol, and the second data portion is processed according to a second protocol.

### TECHNICAL FIELD

The present disclosure relates generally to communication environments, and more particularly, to a uniform message header framework across protocol layers.

### BACKGROUND

In a layered communication system, each layer of a communication stack provides one or more services for communicating and/or processing data. For example, a layer may provide error correction, receipt acknowledgment, encryption, message routing, application-specific processing, and the like. One example of a layered communication architecture is described in OSI/IEC 7498-1, entitled “Information technology—Open Systems Interconnection—Basic Reference Model: The Basic Model,” Second Edition, 1994. The OSI model includes seven layers, each layer using a specific protocol to process and communicate data. The seven layers of the OSI model include a physical layer, data link layer, network layer, transport layer, session layer, presentation layer, and application layer.

In the OSI model, each message transmitted from one communication entity to another includes an original data portion encapsulated by one or more headers corresponding to layers within the OSI communication architecture. Each header is layer-specific, and therefore contains a particular set of fields arranged in a manner particular to a specific protocol used for processing the header. For example, the Transport Control Protocol (TCP) header, used at the transport layer, includes the following fields arranged in the following order: a 16-bit source port field, a 16-bit destination port field, a 32-bit sequence number field, a 32-bit acknowledgment number field, a 4-bit data offset field, a 6-bit reserved field, a 6-bit control bits field, a 16-bit window field, a 16-bit checksum field, a 16-bit urgent pointer field, a variable length options and padding field, and a variable length data field. The Internet Protocol (IP) header has a different set of fields having different lengths and arranged in a different order, including a 4-bit version field, a 4-bit Internet header length (IHL) field, an 8-bit type of service field, a 16-bit total length field, a 16-bit identification field, a 3-bit control flags field, a 13-bit fragment offset field, an 8-bit time to live field, an 8-bit protocol field, a 16-bit header checksum field, a 32-bit source address, a 32-bit destination address field, a variable length option and padding field, and a variable length data field.

Because the protocols used at each layer of the OSI model employ different headers, as described above in connection with TCP and IP, a different processing package (e.g., software, firmware, and/or hardware module for processing data) at each layer must be used to implement a unique protocol to process the corresponding header for that layer. The use of different processing packages in this manner raises the cost and the complexity of the communication system, and thus inhibits the introduction of new protocols to the communication system.

One method of improving efficiency of the OSI protocol stack operations is described in U.S. Pat. No. 6,480,507 (the '507 patent) issued to Mercer et al. on Nov. 12, 2002. The '507 patent describes a method of using buffers to store encapsulation data as the message data propagates down the protocol stack. The method reduces the amount of processing necessary at each layer by placing each layer header in a buffer as the message propagates down the protocol stack, thus decreasing the amount of data to be processed by the processing package at each layer.

Although the system of the '507 patent may decrease data to be processed at each layer, it still fails to reduce the number of processing packages necessary to process messages encapsulated with OSI headers. Thus, the system described in the '507 patent still requires different processing packages for each different layer, which adds to the cost and complexity of the system and inhibits the introduction of new protocols to the communication system.

The disclosed system is directed to overcoming one or more of the problems set forth above.

### SUMMARY OF THE INVENTION

In one aspect, the present disclosure is directed to a method of communicating messages. The method includes sending a message. The message includes a first protocol data unit (PDU) having a first data portion and a first header portion. The first header portion includes a first set of fields containing first data and arranged according to a first structure. The first data portion includes a first service data unit (SDU) having a second data portion and a second header portion. The second header portion includes the first set of fields containing second data and arranged according to the first structure. The method further includes receiving the message and processing the first data and the second data for each of the first and second header portions using the same header processing protocol. The method additionally includes processing the first data portion according to a first protocol and processing the second data portion according to a second protocol.

In another aspect, the present disclosure is directed to a system for transmitting messages having a uniform message header framework. The system includes a first computer system for providing a message. The first computer system includes a first module for creating a first protocol data unit (PDU) having a header portion and a data portion. The first header portion includes a first set of fields containing first data and arranged according to a first structure. The first computer system further includes a second module for encapsulating the PDU with a second header portion to create a second PDU. The second header portion includes the first set of fields containing second data and arranged according to the first structure, such that the same header processing protocol used to create the first set of fields in the first header portion is also used to create the first set of fields in the second header portion. The first computer system additionally includes an interface for transmitting at least the second PDU over a communication medium.

In another aspect, the present disclosure is directed to a system for receiving messages having a uniform message header framework. The system includes a first computer system for receiving a message. The first computer system includes an interface for receiving at least a first protocol data unit (PDU) having a header portion and a data portion. The first header portion includes a first set of fields containing first data and arranged according to a first structure. The first computer system further includes a first module for processing the first PDU according to a first protocol, and a second module for processing a second PDU included as a service data unit (SDU) in the first PDU according to a second protocol. The second header portion includes the first set of fields containing second data and arranged according to the first structure, wherein the same header processing protocol used to process the first set of fields in the first header portion is also used to process the first set of fields in the second header portion.

### BRIEF DESCRIPTION OF THE DRAWINGS

FIG. 1 is a block diagram illustrating an exemplary protocol stack architecture consistent with certain disclosed embodiments;

FIG. 2 is a diagram of a first exemplary protocol data unit consistent with certain disclosed embodiments;

FIG. 3 is a diagram of a second exemplary protocol data unit consistent with certain disclosed embodiments;

FIG. 4 is a flow chart illustrating an exemplary method consistent with certain disclosed embodiments.

### DETAILED DESCRIPTION

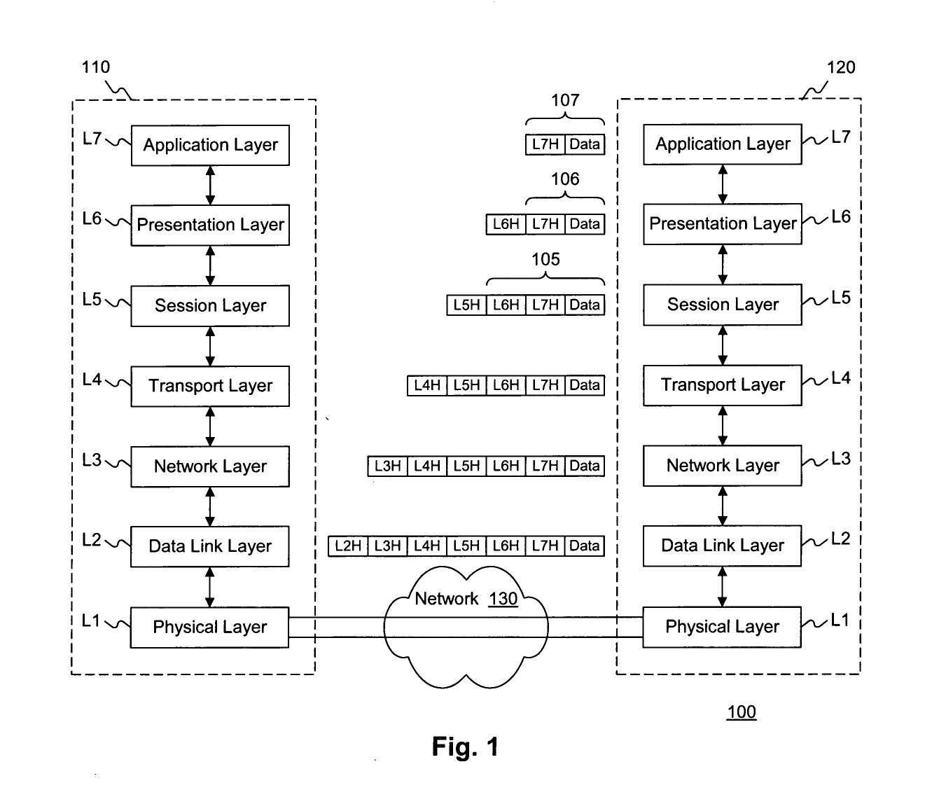

FIG. 1 depicts an exemplary system 100 for implementing one or more disclosed embodiments. The system may include any number of computer systems 110, 120 or other communication systems, and may include one or more networks 130 over which the computer systems may communicate. Computer systems 110 and 120 may include one or more computer or data processing devices that have hardware (e.g., processors, storage memory, data buses, network interface, etc.), software (e.g., application programs, operating systems, other executable program code written in any known programming language such as C, C++, Java™, etc.), and/or firmware (e.g., software embedded in a hardware device). One or more hardware, software, and/or firmware modules may be used to process data in accordance with the disclosed embodiments.

In one embodiment, communications over system 100 use a layered communication architecture including seven communication layers L1 through L7. The physical layer (L1) is the lowest layer in the architecture, and the application layer (L7) is the highest. Each layer L1 through L6 provides services (e.g., performs error-correction, data routing, encryption, etc.) to the next highest layer according to a specific protocol. Thus, for example, the presentation layer performs presentation layer services (e.g., identifying and selecting a transfer syntax) for the application layer data, the network layer performs network layer services (e.g., data routing services, receipt confirmation, etc.) for the transport layer data, etc.

In communications between computer systems, data to be sent from a first computer system (e.g., system 110) to a second computer system (e.g., system 120) begins at a layer in the first system. A layer processing package at the sending system (e.g., system 110), which may include one or more software, firmware, and/or hardware modules designed to process data at a given layer (e.g., software programs written in C, C++, Java, or other known programming languages; network interface cards designed to send and receive network communications, etc.), will encapsulate the data with a layer-specific header and optionally a layer-specific footer, also referred to as a trailer. The header and optional footer contain information that instructs the corresponding receiving processing package at the receiving system (e.g., system 120) how to process the received data. In one embodiment, the header appears before the data being sent, while the footer follows the data. The term “header,” as disclosed, may refer to a header and/or footer used to encapsulate data. Because a header is appended to data at a specific layer, the header may be associated with, and is processed according to, a specific protocol that is used at the layer used to communicate data between different computer systems.

In one embodiment, data to be communicated from one system (e.g., system 110) to another system (e.g., system 120) may originate at the application layer (L7). The original data is then encapsulated with an L7H header, and both the L7H header and the L7 data may be passed down to a next lower layer (e.g., presentation layer L6). The L7H header together with the L7 data are referred to as a protocol data unit (PDU) for layer seven, or L7 PDU. That is, the L7H header together with the L7 data are a complete data unit that will eventually be processed by a corresponding L7 processing package (e.g., software, firmware, and/or hardware module for processing the L7 data) at system 120 according to the features and requirements of the L7 protocol used by that package. In FIG. 1, the L7 PDU is shown as PDU 107.

When the L6 processing package receives the L7 PDU, it performs a service on the L7 PDU. For example, at system 110, the L6 processing package may further encapsulate the L7 PDU with a L6H header. The L6H header may contain information that instructs the receiving L6 processing package at system 120 how to process the received data. Thus, the L6H header is associated with, and is processed according to, a specific protocol that is used to communicate data between L6 processing packages on different computer systems. Because the L7 PDU is serviced by the L6 processing package, the L7 PDU encapsulated by the L6H header is referred to as a service data unit (SDU) of L6, or an L6 SDU. In FIG. 1, the L6 SDU, which includes the same data as the L7 PDU, is shown as SDU 106.

In one embodiment, the above described encapsulation process continues all the way down the protocol stack. Thus, the L6H header and L6 SDU constitute a L6 PDU, which is passed to L5 and encapsulated with a L5H header to become the L5 SDU (FIG. 1, 105). The resulting L5 PDU is then passed to L4 and encapsulated with a L4H header to become the L4 SDU, etc., until the original L7 data is encapsulated with headers from each layer, thus forming a layered message to be communicated via the physical layer to computer system 120. The entire encapsulated message is then transmitted over one or more physical media (e.g., coaxial cable, telephone wire, wirelessly via RF or satellite signal, etc.) to computer system 120. The message may be sent directly or through one or more intermediary devices and/or networks. The message is then received by the physical layer L1 at computer system 120 and passed to the data link layer L2.

Upon receiving the message encapsulated with an outermost L2 header (i.e. an L2 PDU), the receiving system 120 performs the inverse process as the sending system 110. That is, an L2 processing package at receiving system 120 processes the L2H header according to the L2 protocol, thereby performing a service on the L2 SDU. The L2 SDU, which is an L3 PDU, is then passed to L3 and is processed by the L3 processing package. The L3 processing package processes the L3H header according to the L3 protocol, therefore performing a service on the L3 SDU. The L3 SDU, which is an L4 PDU, is then passed to L4 and is processed by the L4 processing package. This process continues until the L7 PDU is received by the L7 processing package at system 120. In one embodiment, the L7 processing package at computer system 120 then processes the L7 header according to the L7 protocol, and the original L7 data may then be processed by the L7 application at system 120.

It should be noted that not every entity that processes data according to the disclosed embodiments includes processing packages for all seven layers. For example, in one embodiment, routers that process PDUs may be designed to only process the first three layers (i.e. physical, data link, and network layers), as they only need to route higher layer data through a network without further processing the data. In another embodiment, for example, certain application programs may not require the services of certain layers (e.g., session layer, presentation layer, etc.). Therefore, not all layers are necessarily present in every communication made using the disclosed communication architecture. Furthermore, in another embodiment, a layer may employ more than one protocol to process data. Thus, a protocol, which refers to a set of steps performed in processing data, may include a number of protocols that each include a subset of the set of steps.

The uniform message header framework implemented according to the disclosed embodiments uses a standard set of header fields, referred to as a “framework header,” to implement a common protocol, referred to as a frame header protocol. This protocol is used to process framework headers at each of a plurality of layers in a communication stack. The framework header includes mandatory header fields and optional header fields. Each of these fields may have a predetermined set length. The mandatory fields are included in the PDU header for every layer that uses the framework header protocol. The optional fields may or may not be included in the framework header, depending on the layer and the protocol being used. Using the framework header to encapsulate different layers in the communication stack reduces the number and complexity of processing packages necessary to process different PDUs at different layers.

The PDUs described hereafter will be discussed in terms of a header portion, which in certain embodiments includes a framework header, and a data portion, which may include an SDU and/or other message data. The framework header may be used to encapsulate a set of layers. For example, in one embodiment, the framework header is used in each of the application, presentation, session, and transport layer headers. In another embodiment, the framework header is appended to layers 2 through 7 of the protocol stack. It should be noted that although the disclosed embodiments describe a layered communication architecture having the seven layers described in the OSI communication architecture, the uniform message header framework disclosed herein may be used for any layered communication architecture. In addition, the uniform message header framework described herein may be used to add new layers to existing communication protocols or to create entirely new layered communication stacks that employ new communication protocols.

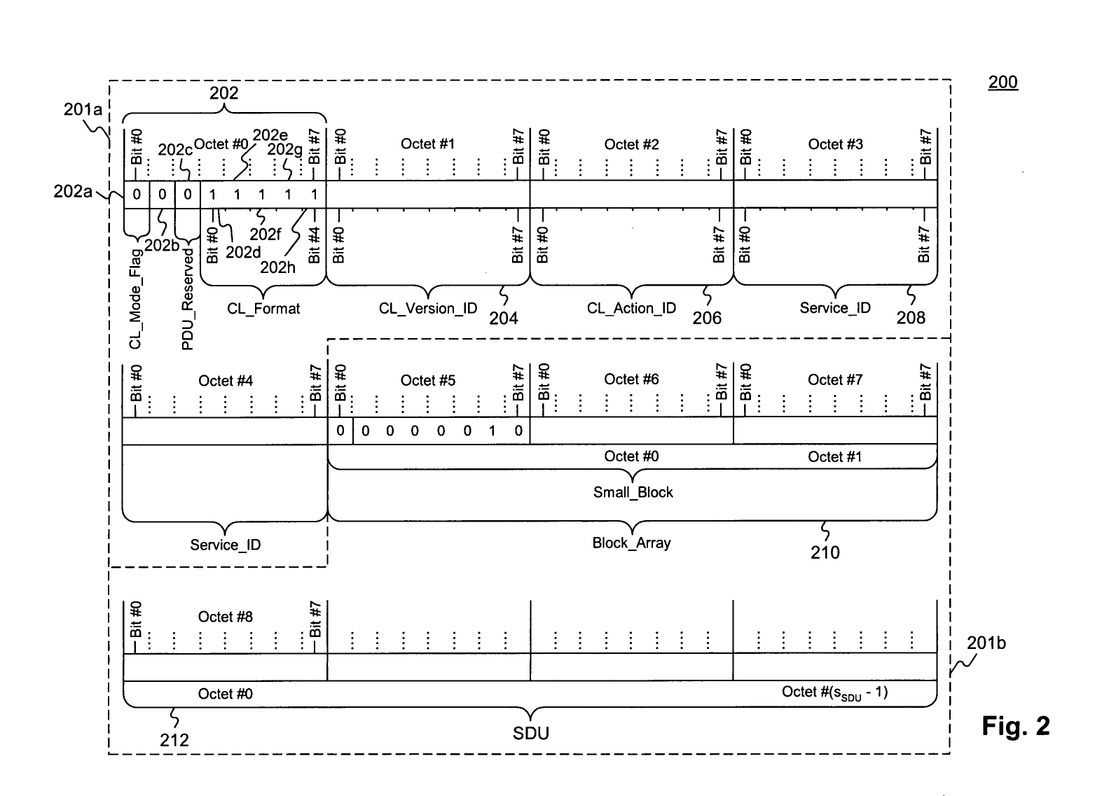

FIG. 2 depicts an exemplary embodiment of a PDU 200 that includes a framework header 201a associated with a particular layer of a communication stack, and a data portion 201b. Data portion 201b may include an SDU from or for a higher layer (i.e., a layer above the particular layer), and may include additional message data. In one embodiment, framework header 201a includes a set of mandatory fields 202 and may include a set of one or more optional fields 204, 206 and 208. Data portion 201b may include block array 210 and/or SDU 212.

In the embodiment depicted in FIG. 2, the set of mandatory header fields 202 includes eight 1-bit fields, and the optional fields include 8-bit field 204, 8-bit field 206, and 16-bit field 208. Fields 202 include a mode field 202a, a connection field 202b, a PDU reserved field 202c, and five format fields 202d, 202e, 202f, 202g, and 202h. The data in these fields determines how a processing package that receives the PDU will process the remainder of the PDU.

For example, mode field 202a indicates whether PDU 200 is a connectionless or connection-oriented PDU. In a connectionless mode of communication, there is no explicit link between the PDU of a given message and the PDU of a previous or subsequent message. In a connection-oriented mode of communication, there is an explicit link defined in the PDU that relates a given message to a previous or subsequent message. Connectionless and connection-oriented PDUs include different optional headers. In PDU 200, mode field 202a is set to 0, indicating a connectionless PDU. In another embodiment, the mode field may be set to 1, which indicates a connection-oriented PDU. It should be noted that the value of the fields used for designating states, status, etc., are not limited to those described herein. Any values or number of bits may be used in these fields to designate a desired state, status, etc., of PDU 200. The data in mode field 202a informs the processing package of the meaning of the data following mode field 202a, and thus instructs the processing package how to interpret the remainder of PDU 200. For example, in one embodiment, if the mode field indicates a connectionless PDU (e.g. has a value of 0), then the processing package processing the PDU knows that the 8 bits following the mandatory header (i.e. octet #1) may correspond to version ID field 204, the next 8 bits (i.e. octet #2) may correspond to action ID field 206, the next 16 bits (i.e. octets #3 and 4) may correspond to service ID field 208, the next 24 bits (i.e. octet #5-7) may correspond to a block array 210, and the final remaining bits, which may include any number of octets, may correspond to an SDU. Other values may be used in field 202a to designate other types of PDUs.

Field 202b is a connection field that contains information related to a sender or receiver of PDU 200. For connectionless PDUs, such as the one depicted in PDU 200, a processing package processing PDU 200 will ignore any information in field 202b. Field 202c is a reserved field that may be used for additional functions by a processing package or other system. Fields 202d-202h are connectionless mode format fields. The data in these fields instructs the processing package whether each of PDU fields 204, 206, 208, 210, and 212 are set and thus include information to be used by a processing package. For example, the data in field 202d (i.e., bit #0) informs the processing package whether version ID field 204 is set. If the data in field 202d has a “set” value (e.g., has a value of 1), then the version ID field 204 is set, and the processing package knows to process the bits in octet #1 as version ID field 204.

In a similar manner, the data in fields 202e, 202f, 202g, and 202h inform the processing package whether respective action ID field 206, service ID field 208, block array field 210 and SDU field 212 are set and should be processed as corresponding header fields by the processing package. If any of the format field bits have “not set” values (e.g., a value of 0), then the corresponding PDU header field is not set and the processing package will process the PDU accordingly. For example, in one embodiment, if field 202d is 0, then the processing package receiving the PDU assumes version ID field 204 is present, but will ignore any data stored in the version ID field 204. In another embodiment, if field 202d is 0 and, for example, field 202e is 1, then the processing package receiving the PDU assumes version ID field 204 is not present, and processes octet #1 as action ID field 206 and other optional header fields in a similar manner depending on the data in corresponding fields 202f, 202g, and 202h.

Version ID field 204, if set (e.g., format field 202d has a value of 1), identifies the version of the connectionless protocol chosen by the entity that created PDU 200. Accordingly, optional field 204 identifies to a receiving processing package the version of a protocol to use in processing the data in PDU 200.

Action ID field 206, if set (e.g., format field 202e has a value of 1), identifies the action of the connectionless protocol taken or desired by the entity that created PDU 200 (e.g., a processing package at computer system 110). The particular action identified depends on the service and the protocol version used. For example, in one embodiment where connectionless messages are transmitted, actions may include transfer data, report error, respond to request, etc.

Service ID field 208, if set (e.g., format field 202f has a value of 1), identifies either the previous service (e.g., layer) in the stack that just processed data (for outgoing messages) or the next service (e.g., layer) in line to process data (for incoming messages). In one embodiment, if service ID field 208 is set, then either block array field 210 or the SDU field 212 must also be set. If service ID field 208 is not set (e.g., format field 202f has a value of 0), then PDU 200 is either located at the first service (e.g., layer) to process data for an outgoing message, or is located at the last service (e.g., layer) to process data for an incoming message.

Block array field 210, if set (e.g., format field 202g has a value of 1), may include block array overhead (e.g., octet #5), and may include protocol control information (PCI). The PCI is protocol specific information to be interpreted by a processing package according to the service, protocol version, and action indicated in the PDU header. Although shown as three octets, block array field 210 may include any number of octets. In one embodiment, the block array overhead indicates the number of octets included in block array field 210.

SDU field 212, if set (e.g., format field 202h has a value of 1), includes an SDU (e.g., a PDU for the next highest layer). In one embodiment, because the SDU is a PDU for the next highest layer, and the SDU contains at least the same mandatory header fields 202 as PDU 200. Furthermore, the PDU for the next highest layer may include a further SDU for an even higher layer. In this manner, PDU 200 may include a set of recursive SDUs, each encapsulated by a header that includes at least the mandatory header fields 202 shown in FIG. 2.

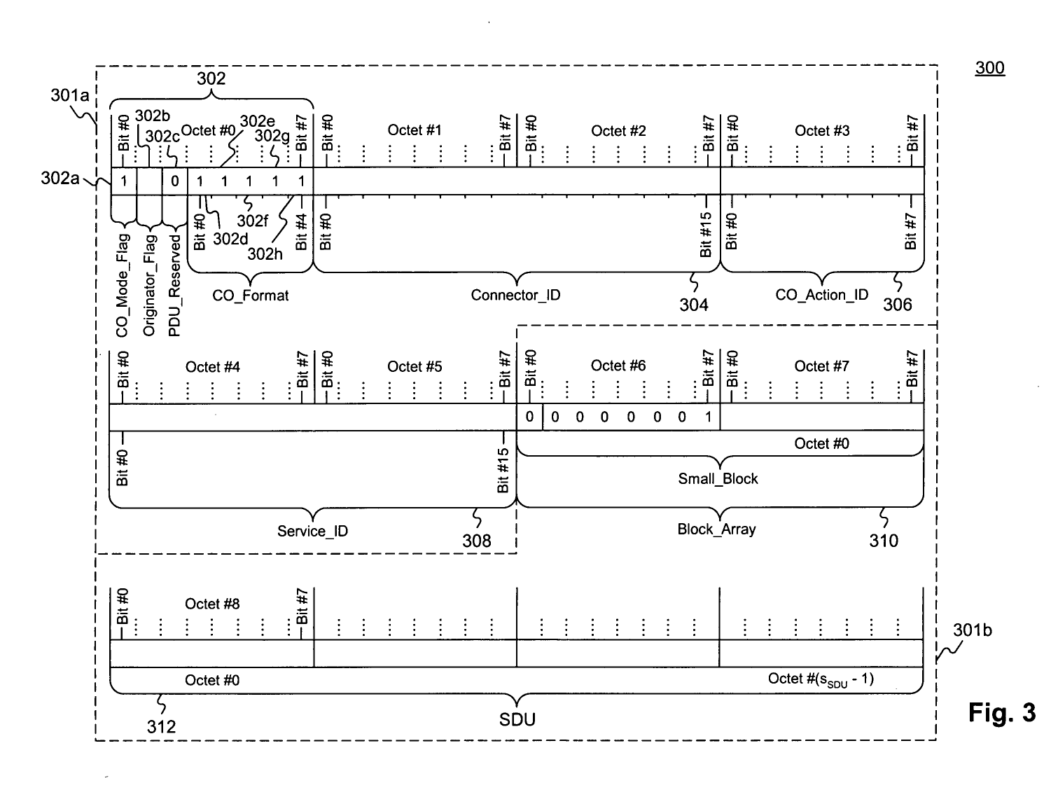

FIG. 3 depicts an exemplary embodiment of a PDU 300 that includes a framework header 301a associated with a particular layer of a communication stack, and a data portion 301b. Data portion 301b may include an SDU from, or for, a higher layer (i.e., a layer above the particular layer), and may include additional message data. In one embodiment, framework header 301a includes a set of mandatory fields 302 and may include a set of one or more optional fields 304, 306 and 308. Data portion 301b may include block array 310 and/or SDU 312.

In the embodiment depicted in FIG. 3, the set of mandatory header fields 302 includes eight 1-bit fields, and the optional fields include 16-bit field 304, 8-bit field 306, and 16-bit field 308. Fields 302 include a mode field 302a, a connection field 302b, a PDU reserved field 302c, and five format fields 302d, 302e, 302f, 302g, and 302h. The data in these fields determines how a processing package that receives the PDU will process the remainder of the PDU.

For example, the data in mode field 302a indicates whether PDU 300 is a connectionless or connection-oriented PDU. Connection-oriented PDU 300 may include different optional header fields from connectionless PDU 200 shown in FIG. 2, but may include the same sized mandatory header (e.g., 302) having the same field structure (e.g., a first 1-bit mode field, a second 1-bit connection field, a third 1-bit reserved field, and five 1-bit format fields). In PDU 300, the mode field 302a is set to 1, indicating a connection-oriented PDU. The data in mode field 302a informs the processing package of the meaning of the data following mode field 302a, and thus instructs the processing package how to interpret the remainder of PDU 300. For example, in one embodiment, if mode field 302a indicates a connection-oriented PDU (e.g. has a value of 1), then the processing package that processes the PDU is informed that the 16 bits following the mandatory header (i.e. octets #1 and 2) may correspond to connector ID field 304, the next 8 bits (i.e. octet #3) may correspond to action ID field 306, the next 16 bits (i.e. octets #4 and 5) may correspond to service ID field 308, the next 16 bits (i.e. octet #6 and 7) may correspond to a block array 310, and the final remaining bits, which may include any number of octets, may correspond to an SDU. Other values may be used in field 302a to designate other types of PDUs.

Field 302b is an originator field that identifies the source of PDU 300 (e.g., whether the PDU is sent by a client entity or a server entity). Because connection-oriented services involve the exchange of information between two entities (e.g., a connection, or conversation), the processing packages in a connection-oriented communication must be able to distinguish whether PDU 300 is destined for a client (e.g., an entity using services of another entity) or a server (e.g., an entity providing services to another entity). Thus, field 302b indicates the originator entity of PDU 300.

Field 302c is a reserved field that may be used for additional functions by a processing package or other system. Fields 302d-302h are connection-oriented mode format fields. The data in these fields instructs the processing package whether each of PDU fields 304, 306, 308, 310, and 312 are set and thus include information to be used by a processing package. For example, the data in field 302d (i.e., bit #0) informs the processing package whether connector ID field 304 is set. If the data in field 302d has a “set” value (e.g., a value of 1), then the connector ID field 304 is set, and the processing package knows to process the bits in octets #1 and 2 as connector ID field 304.

In a similar manner, the data in fields 302e, 302f, 302g, and 302h inform the processing package whether respective action ID field 306, service ID field 308, block array field 310 and SDU field 312 are set and should be processed as corresponding header fields by the processing package. If any of the format field bits have a “not set” value (e.g., a value of 0), then the corresponding header field is not set and the processing package will process the PDU accordingly. For example, in one embodiment, if field 302d is 0, then the processing package receiving the PDU assumes connector ID field 304 is present, but will ignore any data stored in the connector ID field 304 (e.g., will ignore any data stored in octets #1 and 2). In another embodiment, if field 302d is 0 and, for example, field 302e is 1, then the processing package receiving the PDU assumes connector ID field 304 is not present, and processes octet #1 as action ID field 306 and other optional header fields in a similar manner depending on the data in corresponding fields 302f, 302g, and 302h.

Connector ID field 304, if set (e.g., format field 303d has a value of 1), identifies a connector for a client entity that is using the connection. Accordingly, field 304 instructs a receiving processing package which client entity is associated with the connection. The particular connector identified in field 304 depends in part upon the service being performed on the PDU.

Action ID field 306, if set (e.g., format field 302e has a value of 1), identifies the action of the connection-oriented protocol taken, or desired, by the client and server entities associated with PDU 300. The particular action identified depends on the service and the protocol version used, and is negotiated by the client and server during connection establishment. For example, in one embodiment where connection-oriented messages are transmitted, actions may include initiate connection, accept connection, reject connection, transfer data, query state, verify state, report error, initiate disconnect, accept disconnect, reject disconnect, abort connection, etc.

Service ID field 308, block array field 310, and SDU field 312, if set, may include similar information and perform similar functions as described above in connection with fields 208, 210, and 212 of PDU 200.

The disclosed PDU and framework header is exemplary for any layer of a layered communication architecture. For example, in one embodiment, layers 4 through 7 of an OSI-type stack (e.g., the transport, session, presentation, and application layers) may use a framework header structure similar to that shown in FIGS. 2 and 3. In another example, layers 2 through 5 of an OSI-type stack may use a framework header structure similar to that shown in FIGS. 2 and 3. Furthermore, framework header structures may be used across different communication layers in a communication stack having more or fewer than seven layers, and that does not necessarily follow the format of the OSI model.

As described in the examples above, by using the uniform message header framework of the disclosed embodiments, a single processing package can process multiple layers in the protocol stack using a common instruction set. The framework header may include mandatory header fields containing control information and optional header fields that contain additional control information for processing packages. In one embodiment, the mandatory and optional header fields include those shown in FIGS. 2 and/or 3. However, the mandatory and optional header fields may include any desired fields depending on the protocol being used, and are not limited to those shown in FIGS. 2 and 3.

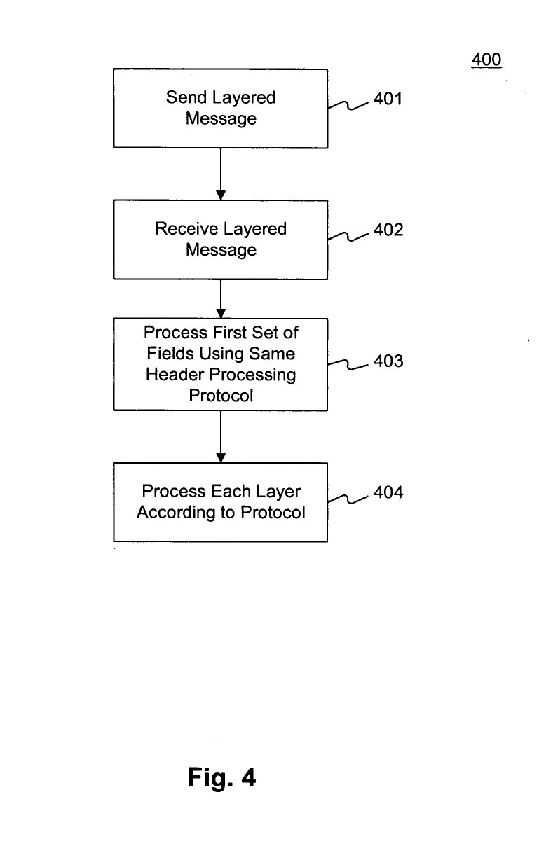

FIG. 4 shows a flowchart of an exemplary method of communication (400) that uses a uniform message header framework consistent with certain disclosed embodiments. In step 401, a layered message (e.g., PDU) is sent across one or more physical media (e.g., coaxial cable, telephone wire, wirelessly via RF or satellite signal, etc.). The layered message may include two or more layers, with at least two layers including a uniform framework header structure. As such, at least a first layer of the message and a second layer of the message include a header portion having at least a first set of fields arranged according to a first structure. The message may be sent from a computer system or other type of system that uses layered communications. In step 402, the message is received. For example, the message may be received at a computer system or other type of system that uses layered communications. The message is then processed at the receiving system (step 403). In one embodiment, the destination system may process the first set of fields for each header using the same header processing protocol. In one embodiment, the destination system may thus process the first set of fields for each header using the same processing package. At each layer, the destination system may process the corresponding layer of the message according to a particular protocol implemented on the system (step 404). The protocol to be used may be designated in one or more header fields of the PDU. Thus, method 400 permits use of a uniform message header framework to implement communications in a layered communication system.

### INDUSTRIAL APPLICABILITY

The disclosed uniform message header framework may be applicable to any type of computer system or other system that implements layered communications. For example, the disclosed embodiments may be used to facilitate communications between personal computers (PCs), mobile devices (e.g., laptop computers, palm-top computers, cellular phones, PDAs, etc.), network-enabled appliances (e.g., Internet-enabled home appliances), automobiles, machines and equipment (e.g., backhoe loaders, dozers, dump trucks, other work-related machines, etc.), routers, switches, and other devices.

In addition, the disclosed uniform message header framework may be used on any of a number of layers of data in a layered communication system. For example, the disclosed framework header may be used for the top four layers (e.g. L4, L5, L6, and L7) of a seven-layer communication stack such as an OSI-type stack that includes an application layer, presentation layer, session layer, transport layer, network layer, data link layer, and physical layer. Further, the framework header may be used for other layers of other types of communication stacks. In one embodiment, the disclosed framework header may be used to encapsulate existing protocol layers, such as the FTP protocol or the TCP protocol. For example, the disclosed framework header may be used to add an encryption layer and/or error correction layer, among other layers, to one or more existing communication protocols. Or, the framework header may be used to create a new protocol stack consisting of entirely new protocols.

In one embodiment, a single processing package may be used to process different layers of the protocol stack, thereby decreasing the costs and complexity of a layered communication system. Furthermore, the uniform structure of the header that may be used for different protocols allows new protocols or layers to be easily added to the communication system.

It will be apparent to those skilled in the art that various modifications and variations can be made to the uniform message header framework. Other embodiments will be apparent to those skilled in the art from consideration of the specification and practice of the disclosed uniform message header framework. It is intended that the specification and examples be considered as exemplary only, with a true scope being indicated by the following claims and their equivalents.

What is claimed is:

1. A method of communicating messages, comprising:
sending a message, the message comprising:
a first protocol data unit (PDU) including a first data portion and a first header portion, wherein the first header portion includes a first set of fields containing first data and arranged according to a first structure, and wherein the first data portion includes a first service data unit (SDU) including a second data portion and a second header portion, the second header portion including the first set of fields containing second data and arranged according to the first structure;
receiving the message;
processing the first data and the second data for each of the first and second header portions using the same header processing protocol;
processing the first data portion according to a first protocol; and
processing the second data portion according to a second protocol.

2. The method of claim 1, wherein processing the first data portion according to a first protocol and processing the second data portion according to a second protocol includes processing the first data portion and the second data portion according to different protocols.

3. The method of claim 1, wherein processing the first data and the second data for each of the first and second header portions includes processing the first data from the first header portion and processing second data from the second header portion, the second data being different from the first data.

4. The method of claim 1, further including processing a header portion of one or more additional SDUs included in the first PDU using the same header processing protocol.

5. The method of claim 4, further comprising processing data from the first set of fields for each of a transport layer portion, session layer portion, presentation layer portion, and application layer portion of the PDU using the same header processing protocol.

6. The method of claim 1, further comprising including in the first set of fields a mode field and one or more format fields, and further comprising indicating in the mode field a connection type, and indicating in each of the one or more format fields whether a respective optional header field is set.

7. The method of claim 6, wherein indicating whether a respective optional header field is set includes indicating whether one or more of a version ID field that indicates a protocol version, a connector ID field that indicates a source of the message, an action ID field that indicates an action to be taken, a service ID field that indicates a service to be performed, a block array field that contains data to be processed, and an SDU field that contains a PDU for a communication layer are set.

8. A system for transmitting messages having a uniform message header framework, comprising:
a first computer system for providing a message, the first computer system including:
a first module for creating a first protocol data unit (PDU) having a header portion and a data portion, wherein the first header portion includes a first set of fields containing first data and arranged according to a first structure;
a second module for encapsulating the PDU with a second header portion to create a second PDU, the second header portion including the first set of fields containing second data and arranged according to the first structure, such that the same header processing protocol used to create the first set of fields in the first header portion is also used to create the first set of fields in the second header portion; and
an interface for transmitting at least the second PDU over a communication medium.

9. The system of claim 8, further including a second computer system for receiving the second PDU, the second computer system including a module for processing the first set of fields in both the first header portion and the second header portion, such that the same header processing protocol used to process the first set of fields in the first header portion is also used to process the first set of fields in the second header portion.

10. The system of claim 8, wherein the first computer system further includes one or more additional modules for encapsulating the second PDU with one or more additional header portions, each including the first set of fields containing data and arranged according to the first structure.

11. The system of claim 8, wherein the first PDU is an application layer PDU, and the second PDU includes the first PDU as a service data unit (SDU) and is a PDU for a lower layer than the application layer.

12. The system of claim 8, wherein the second PDU is part of a layered message, the layered message including at least a transport layer portion, a session layer portion, a presentation layer portion, and an application layer portion.

13. The system of claim 8, wherein the first set of fields includes at least a mode field that indicates a connection type and a set of one or more format fields that indicate whether a respective optional header field is set.

14. The system of claim 13, wherein the optional header fields further include one or more of a version ID field that indicates a protocol version, a connector ID field that indicates a source of the message, an action ID field that indicates an action to be taken, a service ID field that indicates a service to be performed, a block array field that contains data to be processed, and an SDU field that contains a PDU for a communication layer.

15. A system for receiving messages having a uniform message header framework, comprising:
a first computer system for receiving a message, the first computer system including:
an interface for receiving at least a first protocol data unit (PDU) having a header portion and a data portion, wherein the first header portion includes a first set of fields containing first data and arranged according to a first structure;
a first module for processing the first PDU according to a first protocol; and
a second module for processing a second PDU included as a service data unit (SDU) in the first PDU according to a second protocol, wherein the second header portion includes the first set of fields containing second data and arranged according to the first structure, and
wherein the same header processing protocol used to process the first set of fields in the first header portion is also used to process the first set of fields in the second header portion.

16. The system of claim 15, further including a second computer system for transmitting the first PDU over a communication medium.

17. The system of claim 15, wherein the first computer system further includes one or more additional modules for processing one or more SDUs included in the second PDU and having one or more respective additional header portions, each header portion including the first set of fields containing data and arranged according to the first structure.

18. The system of claim 15, wherein the first PDU is a transport layer PDU, and the second PDU is a PDU for a higher layer than the transport layer.

19. The system of claim 15, wherein the first PDU is part of a layered message, the layered message including at least a transport layer portion, a session layer portion, a presentation layer portion, and an application layer portion.

20. The system of claim 15, wherein the first set of fields includes at least a mode field that indicates a connection type and a set of one or more format fields that indicate whether a respective optional header field is set.
